(19) United States
(12) Patent Application Publication
(10) Pub. No.: US 2012/0093362 A1
(43) Pub. Date: Apr. 19, 2012

(54) DEVICE AND METHOD FOR DETECTING SPECIFIC OBJECT IN SEQUENCE OF IMAGES AND VIDEO CAMERA DEVICE

(75) Inventors: Zhou LIU, Beijing (CN); Weiguo Wu, Beijing (CN)

(73) Assignee: Sony Corporation, Tokyo (JP)

(21) Appl. No.: 13/238,226

(22) Filed: Sep. 21, 2011

(30) Foreign Application Priority Data
Sep. 21, 2010 (CN) 201010298017.1

(51) Int. Cl. G06K 9/62

(52) U.S. Cl. 382/103

(57) ABSTRACT

A device for detecting a specific object includes: a suspect object region detection unit configured to create a foreground mask of each frame of image in a sequence of images and perform an inter-frame differential process on the foreground masks to detect a suspect object region; a unit for modeling a region with high incidence of false positive configured to, if at least one suspect object region is detected, determine a suspect object region satisfying a predetermined condition as a region with high incidence of false positive and build a model of each determined region; a post-processing unit configured to match each suspect object region not determined as a region with high incidence of false positive against at least one corresponding model, and detect the specific object according to a sequence of mismatching suspect object regions; and determine absence of the specific object if no suspect object region is detected.

### FIELD OF THE INVENTION

The present invention generally relates to the field of pattern recognition, to a technology of image processing and computer vision, and particularly to a device and method for detecting a specific object in a sequence of images and a corresponding video camera apparatus.

### BACKGROUND OF THE INVENTION

It is typically rather significant to detect a specific object in a sequence of video images. For example, if the specific object is a derelict, then detection of such a derelict is significant to keep a public place secured. Detection of a derelict as mentioned here refers to detection of those backpacks, briefcases, etc., possibly with an exploder enclosed therein, which have been purposely abandoned or put in a public place or some crucial sites. Generally a terrorist detonates a bomb in such a package in a timed or remotely controlled way after placing the package. Such a criminal act committed at a low cost, causing considerable danger and highly difficult to prevent and scout for has gradually become one of predominant approaches for a criminal to attempt a bombing attack. Similar cases have emerged constantly, e.g., the series of bombing cases in Madrid, Spain, 2004; the bombing cases in London and Liverpool, Britain, 2005. At present, a derelict is typically detected in a video. During the detection, a video surveillance device installed on the spot analyzes the contents of images in a captured sequence of video images to detect an occurrence event of a derelict.

At present there are a variety of methods in which video based detection of a derelict has been studied, but it is typically required in the existing similar methods to detect moving objects in a scene, then track all the moving objects, determine whether there is a moving object separated from another object and keeping immobile for a period of time and thereby detect a derelict. In a method described in the document by J. Martinez del Rincon, Jorge Jomez J. Elias Herrero and Vehiclelos Orrite Urunela, entitled “Automatic left luggage detection and tracking using multi-camera UKF” in IEEE International Workshop on Performance Evaluation in Tracking and Surveillance (PETS), 2006, for example, moving objects are detected by a background modeling method and tracked by a Kalman filtering method, and finally it is determined under a specific rule whether a specific object (i.e., derelict) has been abandoned. These methods require a tracking process, but a real scene is typically complex, and it is very difficult to track all the moving objects. Therefore such methods result in poor accuracy and low practicability. Although a method for detecting a derelict without any tracking process has been proposed in Chinese Patent Application Publication No. CN101635026A published on Jan. 27, 2010 and entitled “Method for detecting derelict without tracking process”, this method fails to take into account numerous difficulties, e.g., shielding, in a real scene, and results in a large number of false positives and negatives.

### SUMMARY OF THE INVENTION

In view of the foregoing circumstance, it is desired to provide a solution to detect a specific object (e.g., a derelict) in a sequence of images efficiently and accurately.

Embodiments of the invention provide a device and method for detecting a specific object in a sequence of images. Without any tracking process, this device and method makes real-time determination of a region with high probability of false positive (i.e., a region with high incidence of false positive) in a scene of a sequence of images, builds a model of the region with high incidence of false positive and hereupon determines whether a suspect object region resulting from the differential of a foreground mask is a region with high incidence of false positive or is matched with a region with high incidence of false positive, and thereby detects a specific object. This device and method can improve the robustness of a process of detecting a specific object, and can greatly reduce the number of false positives and improve the precision of detecting the object.

Specifically an embodiment of the invention provides a device for detecting a specific object in a sequence of images, which includes:

a suspect object region detection unit configured to create, for a sequence of images including a plurality of frames of images in a predetermined interval of time, a foreground mask of each frame of image in the sequence of images through background modeling, and perform an inter-frame differential process on the created foreground mask to detect a suspect object region;

a unit for modeling a region with high incidence of false positive configured to, if at least one suspect object region is detected by the suspect object region detection unit, determine a region satisfying a predetermined condition among the at least one suspect object region as a region with high incidence of false positive, and built a model of each determined region with high incidence of false positive; and

a post-processing unit configured to, if at least one suspect object region is detected by the suspect object region detection unit, match each suspect object region, which is not determined as a region with high incidence of false positive against at least one corresponding model and detect the specific object according to a sequence of mismatching suspect object regions including all the mismatching suspect object regions which are not matched with respective corresponding model of a region with high incidence of false positive; and, determine absence of the specific object in the sequence of images if no suspect object region is detected by the suspect object region detection unit.

Another embodiment of the invention further provides a method for detecting a specific object in a sequence of images, which includes:

creating a foreground mask of each frame of image in a sequence of images including a plurality of frames of images in a predetermined interval of time through background modeling, and performing an inter-frame differential process on the created foreground mask to detect a suspect object region;

if at least one suspect object region is detected, determining a region satisfying a predetermined condition among the at least one suspect object region as a region with high incidence of false positive, building a model of each determined region with high incidence of false positive;

if at least one suspect object region is detected, matching each suspect object region, which is not determined as a region with high incidence of false positive against at least one corresponding model, and detecting a specific object, in response to the result of matching, according to a sequence of mismatching suspect object regions including all the mismatching suspect object regions which are not matched with respective corresponding models; and, determining absence of the specific object in the sequence of images if no suspect object area is detected.

Another embodiment of the invention further provides a video camera device including the device for detecting a specific object in a sequence of images according to the embodiment of the invention as described above.

A further embodiment of the invention further provides a program product with machine readable instruction codes stored thereon, which when being read and executed by a machine can cause the machine to perform the method for detecting a specific object in a sequence of images according to the embodiment of the invention as described above.

A further embodiment of the invention further provides a storage medium carrying thereon the foregoing program product.

In the solution according to the embodiments of the invention, a model of region with high incidence of false positive can be built to reduce the number of false positives due to the scene complexity in a real scene included in a sequence of images and hence improve the precision of detecting a specific object. Furthermore the use of an inter-frame differential method for a foreground mask to derive a suspect object region can also avoid effectively the drawback in the traditional inter-frame differential method that a specific object (e.g., a derelict) shielded by a moving object can not be detected.

### BRIEF DESCRIPTION OF THE DRAWINGS

The patent or application file contains at least one drawing executed in color. Copies of this patent or application publication with color drawing(s) will be provided by the office upon request and payment of the necessary fee.

The foregoing and other objects, features and advantages of the invention will become apparent from the description of the embodiments of the invention taken in conjunction with the drawings in which identical or similar reference numerals designate identical or similar functional components or steps. In the drawings:

FIG. 1 is a simplified block diagram of a structure of a device for detecting a specific object in a sequence of images according to an embodiment of the invention;

FIG. 2 is a simplified schematic flow chart of an example of a procedure performed by the device illustrated in FIG. 1 to detect a specific object;

FIGS. 3a to FIG. 3c are schematic diagrams illustrating an example of a procedure of deriving a suspect object region through an inter-frame differential process on the foreground mask;

FIGS. 4a to FIG. 4c are schematic diagrams illustrating an example of a false positive due to possibly mistaking an object with a large size for a specific object during detection in the prior art;

FIG. 5 is a simplified flow chart illustrating operation performed by the device for detecting a specific object in a sequence of images according to the embodiment of the invention to determine and built a model of a region with high incidence of false positive;

FIG. 6 is a simplified flow chart illustrating operation performed by the device for detecting a specific object in a sequence of images according to the embodiment of the invention to detect a specific object in a sequence of images by matching against a model of region with high incidence of false positive;

FIG. 7 is a simplified flow chart illustrating operation performed by the device for detecting a specific object in a sequence of images according to the embodiment of the invention to detect a specific object in a sequence of images by comparing with other predetermined types of object regions in the sequence of images;

FIG. 8 is a simplified flow chart illustrating a method for detecting a specific object in a sequence of images according to another embodiment of the invention; and

FIG. 9 is a schematic block diagram illustrating a computer system in which the method and device according to the embodiments of the invention can be embodied.

### DETAILED DESCRIPTION OF THE INVENTION

The embodiments of the invention will be described hereinafter with reference to the drawings. It shall be noted that only those device structures and/or process steps closely relevant to the solution of the invention will be illustrated in the drawings while other details less relevant to the invention will be omitted so as not to obscure the invention due to those unnecessary details. Throughout the drawings, identical or similar constituent elements will be denoted with identical or similar reference numerals.

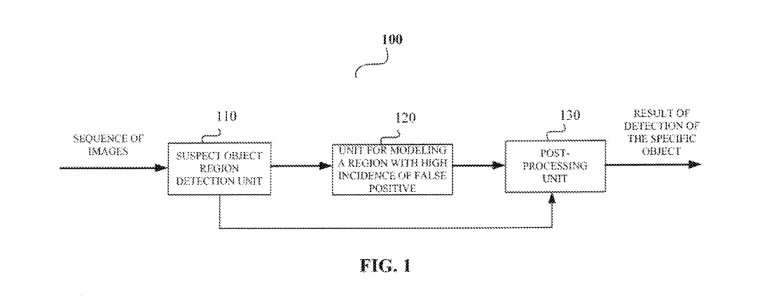

FIG. 1 illustrating a simplified block diagram of a structure of a device 100 for detecting a specific object in a sequence of images according to an embodiment of the invention. As illustrated in FIG. 1, the device 100 includes: a suspect object region detection unit 110 configured to create, for a sequence of images including a plurality of frames of images in a predetermined interval of time, a foreground mask of each frame of image in the sequence of images through background modeling and perform an inter-frame differential process on the created foreground mask to detect a suspect object region; a unit for modeling a region with high incidence of false positive 120 configured to, if at least one suspect object region is detected by the suspect object region detection unit 110, determine a region satisfying a predetermined condition among the at least one suspect object region as a region with high incidence of false positive, and build a model of each determined region with high incidence of false positive; and a post-processing unit 130 configured to, if at least one suspect object region is detected by the suspect object region detection unit 110, match each suspect object region, which is not determined as a region with high incidence of false positive against at least one corresponding model, and detect the specific object based on a sequence of mismatching suspect object regions. Here the sequence of mismatching suspect object regions includes all the mismatching suspect object regions which are not matched with respective corresponding models. The post-processing unit 130 can further be configured to determine absence of the specific object in the plurality of frames of images in the predetermined interval of time, i.e., the sequence of images, if no suspect object region is detected by the suspect object region detection unit 110.

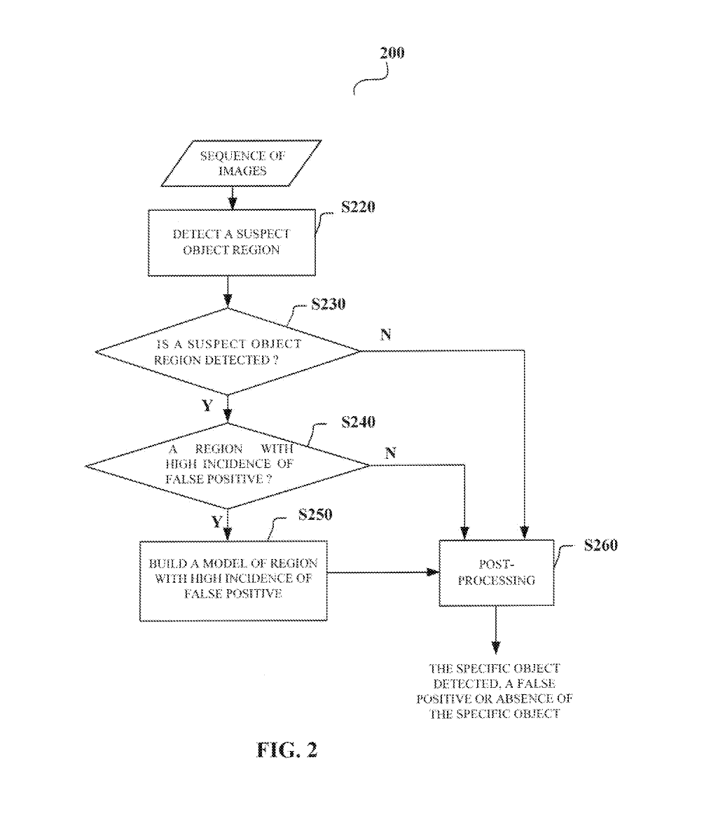

FIG. 2 is a simplified schematic flow chart of an example of a procedure 200 performed by the device 100 illustrated in FIG. 1 to detect a specific object. As illustrated, the process of S220 in the procedure is to detect a suspect object region (i.e., a region in which a specific object to be detected (e.g., a derelict) is possibly included) from a sequence of input images (e.g., a sequence of images including a plurality of frames of images in a certain predetermined interval of time acquired from a video camera device). The process of S230 in the procedure is to determine whether a suspect object region is detected in S220 of the procedure. If the result of the determination is “Yes”, then the process of S240 in the procedure is to determine whether the suspect object region is a region with high incidence of false positive. If so, the process of S250 in the procedure is to built a model of the region with high incidence of false positive; otherwise, the process of S260 in the procedure is to post-process the suspect object region which is not a region with high incidence of false positive to thereby determine whether the suspect object region is the specific object or a false positive. Furthermore if it is determined in S230 of the procedure that no suspect object region is detected, then the process of S260 in the procedure is to determine that the specific object to be detected is absent in the sequence of input images.

In a preferred embodiment, the procedure shown in FIG. 2 may further include a process of generating a library of model of region with high incidence of false positive according to the model of region with high incidence of false positive built in the process of S250. The process of generating the library may by carried out, for example, by the unit for modeling a region with high incidence of false positive 120 shown in FIG. 1.

The procedure 200 performed by the device 100 to detect the specific object will be described in details below in several specific examples.

Firstly an example will be described in which the suspect object region detection unit 110 detects a suspect object region. In this example, the description will be presented taking the specific object being a derelict as an example. Typically a derelict has the following two features: (1) the derelict will cause the background of an occupied region to be changed; and (2) the derelict will keep immobile after being abandoned. Correspondingly the following two steps can be performed to detect a suspect derelict region, i.e., a suspect object region, in a scene of the sequence of images including a plurality of frames of images.

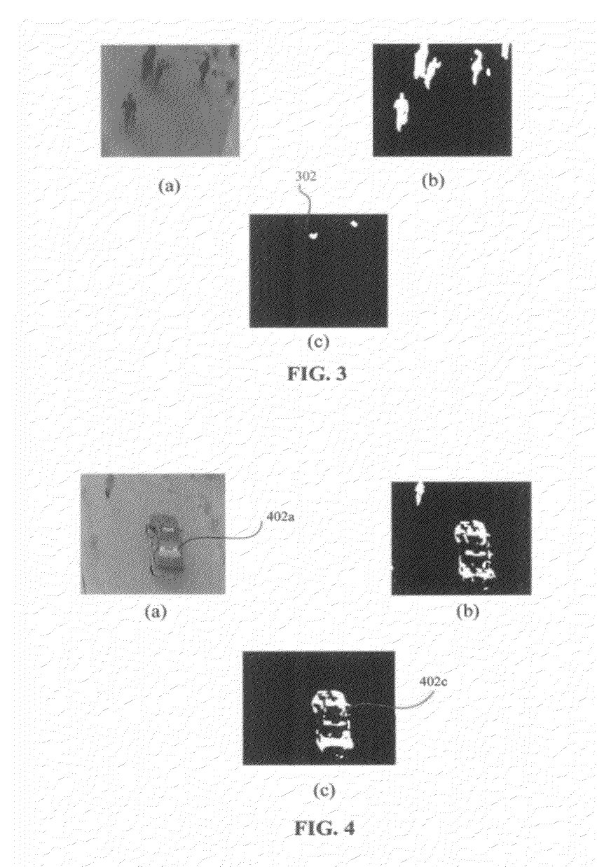

The first step is to extract the region with the changed background from the scene through a method based on background modeling. In view of a real-time requirement of derelict detection, the background can be modeled, for example, using a widely applied method for GMM (Gaussian Mixed Model). Building a model of a background using the method for GMM is well known in the field of image processing, and a repeated description of specific details thereof will be omitted here. In such method for background modeling, it is assumed that the color of the background at each pixel in an image is in Gaussian distributions. Color information of each frame of image in the sequence of images in the predetermined interval of time (e.g., in the last four seconds) is extracted, the method for GMM is applied to the color information of each pixel so that the model is descriptive of the color information of the background at the respective pixels. FIG. 3(b) and FIG. 4(b) illustrate the region with the changed background (i.e., the foreground mask) detected by the method for background modeling. Here the “foreground” refers to any object relative to the “background” in an image (e.g., a person, a vehicle, a specific object to be detected (e.g., a derelict)). As illustrated in FIG. 3(b) and FIG. 4(b), the extracted foreground mask is embodied as a binarized image, and in the binarized image the value “0” represents the black color (the background) and the value “1” represents the white color (the foreground object). Of course, this is merely illustrative and not limiting, and for example, the foreground mask can alternatively be embodied in the form of a grayscale image as required in practice. Furthermore the sequence of images in any interval of time can be taken as an object of processing as required in practice and the invention will not be limited to four seconds in this example.

In the extracted region with the changed background (i.e., the foreground mask), the inter-frame differential process is performed on the derived foreground mask in order to extract pixels belonging to a moving foreground and also staying in the foreground status for the predetermined interval of time (four seconds in this example). With a connectivity-domain analysis, all the suspect derelict regions in the scene of the sequence of images in the predetermined interval of time are extracted to thereby constitute a sequence of suspect derelict regions which includes all the (one or more, i.e., at least one) detected suspect derelict regions. The connectivity-domain analysis is a processing method well known and commonly used in the field of image processing, and a repeated description of details thereof will be omitted here. It shall be noted that since the inter-frame differential process is performed on the foreground mask instead of directly on the sequence of images as usual, the situation in which the shielded derelict can not be detected can be avoided effectively. For example, FIG. 3c illustrates the result of detecting a shielded derelict. As illustrated in FIG. 3c, the drawing reference sign “302” represents a shielded derelict, and apparently the derelict 302 shielded by another object (here a person) will not be detected (that is, a false negative will occur with respect to the derelict) if the inter-frame differential process is performed simply on the sequence of images as in the prior art.

As described above, it can be determined that the specific object to be detected, e.g., a derelict, is not included in the sequence of images in the predetermined interval of time if no suspect object region is detected by the background modeling and the inter-frame differential process for the foreground mask as described above. The following description will be mainly focused on subsequent processes performed in the case that at least one suspect object region is detected by the background modeling and the inter-frame differential process for the foreground mask as described above.

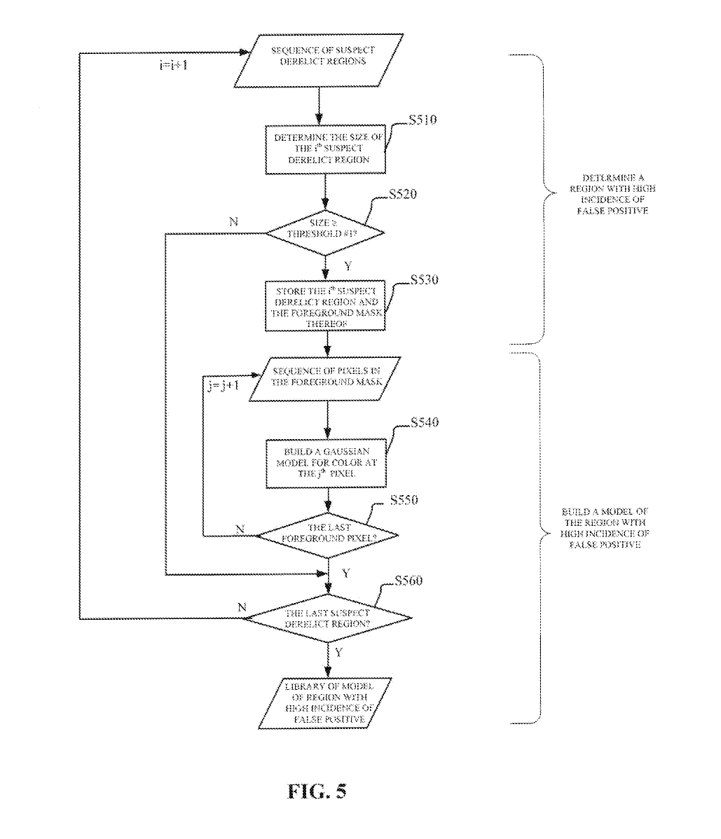

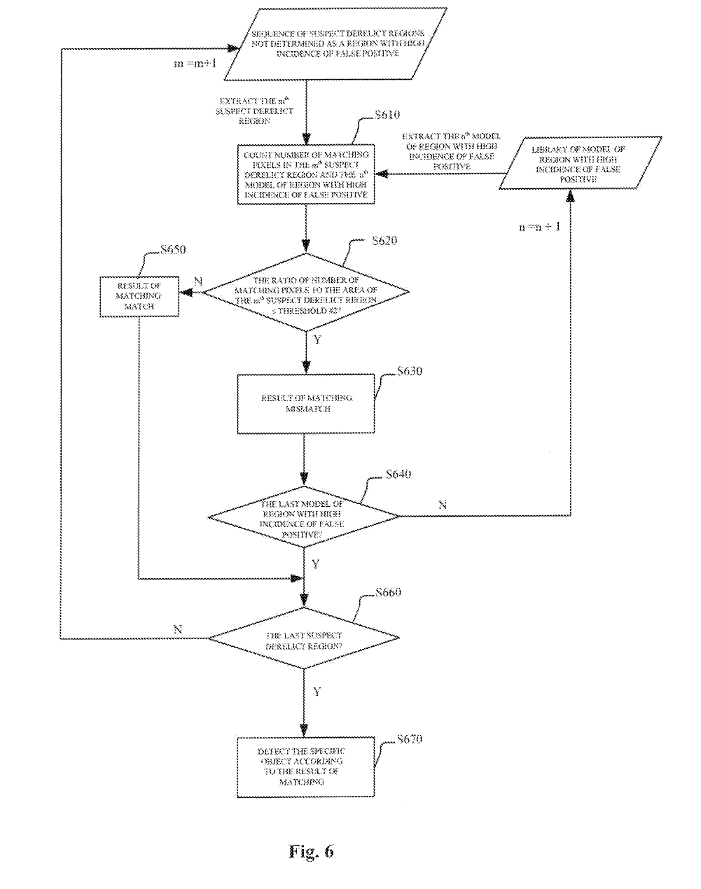

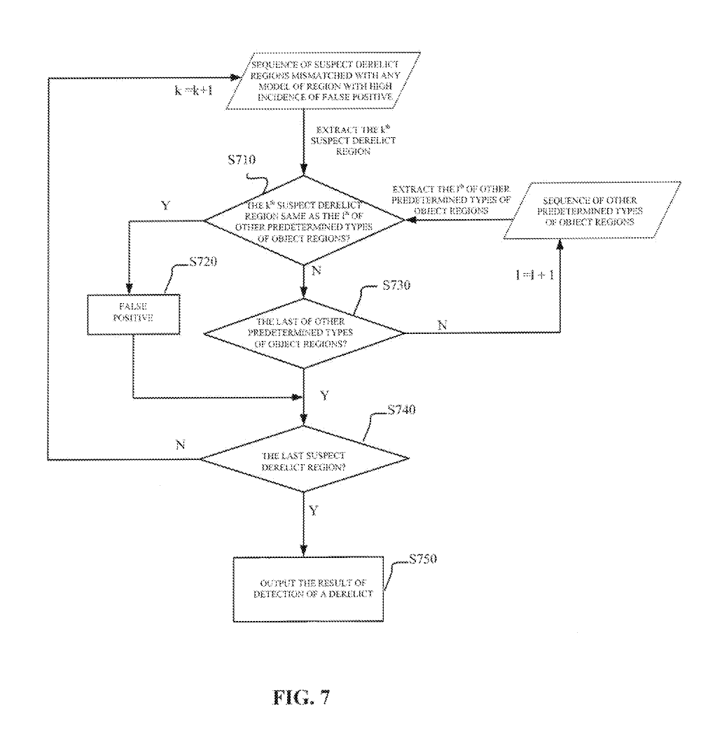

An example of a process performed by the unit for modeling a region with high incidence of false positive 120 of the device 100 in FIG. 1 to determine and build a model of a region with high incidence of false positive will be described with reference to FIG. 5.

In the process of detecting a foreground through the background modeling as described above, a moving object will be integrated slowly into the background model to become a foreground after the moving object stops and is kept immobile for a period of time. Since respective parts of the moving object differ in color from the background, respective regions of the moving object (i.e., the foreground) will also be integrated into the background at different moments of time. In this case, after an object having a large area (e.g., a vehicle) stops and is kept immobile for a period of time, the foreground region will be divided into a plurality of sub-regions as the object is gradually integrated into the background, and at this time the features (e.g., the short duration of immobility, the size and the edge) of the respective sub-regions satisfy the features of a derelict, so they are typically detected as derelicts. FIG. 4b illustrates the result of detecting a foreground after immobility for a period of time, wherein a large object (a vehicle in this example) is detected as a number of small regions. In the result of detecting a derelict as illustrated in FIG. 4c, a part of the sub-regions, e.g., a sub-region 402c corresponding to a vehicle window region 402a in FIG. 4a, may be mistaken for the specific object to be detected (a derelict in this example), thus resulting in a false positive.

In order to remove the false detection due to the foregoing reason, for example, it can be determined by the process as illustrated in FIG. 5 whether a region with high incidence of false positive is present in the sequence of suspect derelict regions detected in the foregoing process of detecting a suspect derelict region, and the sequence of suspect derelict regions includes the at least one detected suspect derelict region. As illustrated in FIG. 5, the size of the i^{th} suspect derelict region in the sequence of suspect derelict regions is extracted in the step S510. It is determined in the step S520 whether the size is larger than or equal to a predetermined threshold #1. If the result of the determination is “Yes”, then the i^{th} suspect derelict region is determined as a region with high incidence of false positive and the region with high incidence of false positive and the foreground mask thereof are stored for later use in the step S530. In this example, the size of the suspect derelict region is the two-dimension area of the region. Dependent upon various situations in practice, such as possible features including the type and the appearance of a derelict, the size can alternatively be, for example, a one-dimension size (e.g., the length, the width) and a three-dimension volume.

A model can be built to describe the acquired region with high incidence of false positive. The foreground mask of the region with high incidence of false positive is derived in the process of S530, and a Gaussian model is built at each pixel representing a foreground (i.e., with a mask value of “1”) in the foreground mask corresponding to the region with high incidence of false positive to describe color information of an object (i.e., a derelict) at the pixel in the processes of S540 to S550. The mean of the Gaussian model is the color value of the pixel at this time, and the variance thereof is predetermined, for example, the variance may be an initial variance of the Gaussian model or an empirical value of the variance.

If the result of the determination of S520 is “No”, it is determined that the suspect derelict region is not a region with high incidence of false positive, and the forgoing processes of determining and building a model of a region with high incidence of false positive in S510 to S550 are performed on the next suspect derelict region. The similar processes are performed on each suspect derelict region in the sequence of suspect derelict regions.

With the foregoing series of processes of S510 to S560, it can be determined which region in the sequence of suspect derelict regions derived in the inter-frame differential process on the foreground masks is a region with high incidence of false positive, a model can be built for each region determined as a region with high incidence of false positive, and the foreground mask of the region with high incidence of false positive and the model thereof are stored to create a library of model of region with high incidence of false positive for use in a subsequent process. In the procedure illustrated in FIG. 5, i and j are natural numbers which represent the serial number of each region in the sequence of suspect derelict regions and the serial number of each pixel in the foreground mask of each region determined as a region with high incidence of false positive, respectively.

As described above, a suspect derelict region satisfying a predetermined condition (e.g., with a size larger than or equal to the predetermined threshold #1) can be determined as a region with high incidence of false positive, thereby avoiding a false positive due to the region with high incidence of false positive (e.g., a false positive due to a vehicle illustrated in FIG. 4) and improving the precision of detecting a derelict. Furthermore, a model of a determined region with high incidence of false positive is built and the model is stored (for example, a library of model of region with high incidence of false positive is generated) so that information on a region with high incidence of false positive derived in the previous detection process can be used in the next detection process, thereby improving the robustness of the process while ensuring the precision of detection.

The following description will be presented with reference to FIG. 6, regarding an example of operation performed by the device for detecting a specific object in a sequence of images according to the embodiment of the invention to detect a specific object (e.g., a derelict) in a sequence of images by means of matching against a model of region with high incidence of false positive.

As illustrated in FIG. 6, in S610, the m^{th} suspect derelict region in the sequence of suspect derelict regions which are not determined as the region with high incidence of false positive is matched against the corresponding n^{th} model of region with high incidence of false positive extracted from the library of model of region with high incidence of false positive. Here the sequence of suspect derelict regions may include one or more, i.e., at least one suspect derelict region. As an example of such a matching process, pixels in the m^{th} suspect derelict region can be counted, wherein the Gaussian models of such pixels are matched with the Gaussian models of pixels at corresponding locations in the n^{th} model of region with high incidence of false positive. For example, if the difference between the color value of a pixel in the m^{th} suspect derelict region and the mean of the Gaussian model of a pixel at a corresponding location in the n^{th} model of region with high incidence of false positive is within twice the variance of the Gaussian model, then the two pixels can be determined as being matched with each other. Of course, any other appropriate condition can be set dependent upon a practical situation for determining whether pixels are matched with each other. For example in an alternative embodiment, probability densities of various colors appearing at each pixel of the model of region with high incidence of false positive can be estimated using a kernel probability density function method. After the density function is built, when the color likelihood (i.e., the value of the probability density function) of a pixel to be matched in a suspect derelict region is larger than a specific threshold, the pixel to be matched is determined as being matched with a corresponding pixel in the corresponding model of region with high incidence of false positive. The threshold can be preset dependent upon a practical situation.

Next it is determined in S620 whether the ratio of the number of the matching pixels to the area of the m^{th} suspect derelict region is smaller than or equal to a predetermined threshold #2, and if the ratio is larger than the second predetermined threshold, then the m^{th} suspect derelict region is determined as being matched with the n^{th} region with high incidence of false positive in S650, which indicates that the m^{th} suspect derelict region is a false positive resulting from stopping of a certain large moving object. The predetermined threshold #2 can be predetermined dependent upon a practical situation. Taking a vehicle as an example of a large moving object, for example, the ratio of the area of the smallest part of the vehicle possibly being a false positive (e.g., a vehicle window) to the area of the entire vehicle can be determined as the predetermined threshold #2. M and n are natural numbers which represent the serial number of each suspect derelict region in the sequence of suspect derelict regions and the serial number of each model in the library of model of region with high incidence of false positive, respectively. If it is determined in S620 that the ratio is smaller than the predetermined threshold #2, then the m^{th} suspect derelict region is determined as being not matched with the n^{th} region with high incidence of false positive in S630.

In the procedure illustrated in FIG. 6, it is determined one by one whether the respective suspect derelict regions which are not determined as a region with high incidence of false positive are matched with a certain model of region with high incidence of false positive in the library of model of region with high incidence of false positive, that is, actually all the models in the library of model of region with high incidence of false positive are taken as the corresponding model of region or models of regions with high incidence of false positive against which the suspect derelict region or regions are to be matched. However in an alternative embodiment, it can be predetermined which model or models in the library of model of region with high incidence of false positive are relevant to a certain suspect derelict region determined as a region with high incidence of false positive, so that only the relevant model of region or models of regions with high incidence of false positive will be taken as the corresponding model of region or models of regions with high incidence of false positive against which the suspect derelict region is to be matched. For example, which model of region or models of regions with high incidence of false positive are relevant to the suspect derelict region can be determined preliminarily by comparing the location of the suspect derelict region relative to that of a region with high incidence of false positive in the scene of the sequence of images. The processing speed can be improved to some extent because it is not necessary to perform exhaustively a matching process against all the models of regions with high incidence of false positive in the library of model of region with high incidence of false positive.

As can be apparent from the foregoing description, “the corresponding model of region or models of regions with high incidence of false positive” against which a suspect derelict region which is not determined as a region with high incidence of false positive is to be matched as mentioned in this disclosure may refer to both all the models in the library of model of region with high incidence of false positive and specific model(s) in the library of model related to the suspect derelict region.

Processes similar to the foregoing processes are performed on each region in the sequence of suspect derelict regions which is not determined as a region with high incidence of false positive. Finally the specific object, i.e., a derelict can be detected in S670 of FIG. 6 as a result of the matching processes of S610 to S660. For example, a suspect derelict region which is not matched with any model in the library of model of region with high incidence of false positive can be determined directly as a region corresponding to a derelict to be detected. In the procedure illustrated in FIG. 6, m and n are natural numbers which represent the serial number of each region in the sequence of suspect derelict regions which is not determined as a region with high incidence of false positive and the serial number of each model in the library of model of region with high incidence of false positive, respectively.

As can be apparent from the procedure illustrated in FIG. 6, the library of model of region with high incidence of false positive is generated by building models of the regions with high incidence of false positive and storing these models, so models of regions with high incidence of false positive created in previous respective processes of detecting a derelict can be used in the current process of detecting a derelict, and the models of regions with high incidence of false positive created in the current process of detecting a derelict can also be used in a subsequent process of detecting a derelict. Thus, the detection of the specific object (e.g., a derelict) performed by the device according to the embodiment of the invention may have a learning-like characteristic, thereby improving both the robustness and the precision of the detection process. Furthermore, though the library of model of region with high incidence of false positive is created by directly storing the models of regions with high incidence of false positive in this example, in another alternative embodiment, the library of model of region with high incidence of false positive can be created, for example, by classifying the respective created models of regions with high incidence of false positive according to their features, or by allocating weights thereto.

As mentioned above, a false positive tends to occur in a region with high incidence of false positive in the process of detecting the specific object, and furthermore the following false positive sometimes may easily occur in a real scene: when an immobile object stops suddenly after moving slightly, a foreground region detected through background modeling is merely a region with the changed background, which is only a fraction of the object, and since the object stops in the end, this fraction of the foreground region will be detected as the specific object, e.g., the derelict. In order to handle such a false positive, a further process can be performed on the sequence of mismatching derelict regions which are obtained from the previous processes and are not matched with any model in the library of model of region with high incidence of false positive in a preferred embodiment. FIG. 7 is an example illustrating such a process.

As illustrated in FIG. 7, it is determined whether the sequence of mismatching derelict regions includes a derelict to be detected by comparing the mismatching derelict regions with other predetermined types of object regions detected in the sequence of input images. The sequence of mismatching derelict regions may include one or more mismatching derelict regions.

As illustrated in FIG. 7, the k^{th} region in the sequence of suspect derelict regions which are not matched with the models of regions with high incidence of false positive is extracted and compared in S710 with the l^{th} object region in a sequence of other predetermined types of object regions detected in the sequence of images, so as to determine whether the k^{th} suspect derelict region is the same as the l^{th} object region, wherein the sequence of other predetermined types of object regions may include one or more other predetermined types of object regions. Here, the sequence of suspect derelict regions which are not matched with the models of regions with high incidence of false positive is the sequence of mismatching suspect derelict regions, which may include one or more suspect derelict regions. If the result of the comparison is “Yes”, then the k^{th} suspect derelict region is determined as a false positive due to the l^{th} object region of the other predetermined types in the process of S720, and then the process is performed on the next region in the sequence of mismatching derelict regions. If the result of the comparison of S710 is “No”, then the procedure goes to S730 to determine whether the k^{th} region has been compared with all object regions in the sequence of other predetermined types of object regions, and if not so, another object in the sequence of other predetermined types of object regions is selected, and the processes of S710 to S730 are repeated. If it is determined in S730 that the k^{th} region has been compared with all object regions in the sequence of other predetermined types of object regions, then the k^{th} suspect derelict region is determined as being corresponding to a derelict region to be detected. The foregoing processes are performed on all the regions in the sequence of mismatching suspect derelict regions, and finally the result of detection with respect to the sequence of mismatching suspect derelict regions is output in S750, that is, whether a derelict is detected or not (e.g., a false positive occurs). This process can avoid effectively the foregoing false positive due to an immobile object which stops suddenly after moving slightly, thereby improving the precision of detection.

Various disclosed methods for detecting a predetermined type of object region in an image can be adopted to detect other predetermined types of object regions (e.g., a vehicle, a person and an animal) in respective frames of images in a sequence of input images. For example, all vehicles in a scene of a sequence of input images can be detected by a method disclosed in Chinese Patent Application Publication No. CN101655914, published on Feb. 24, 2010 and entitled “Training device, training method and detection method”. Of course various well-known methods for detecting a predetermined type of object, e.g., a vehicle, a person, an animal, can also be used to detect such a predetermined type of object region. Such a predetermined type of object region can be detected online together with detection of a derelict or detected in advance for later use prior to detection of a derelict. In the procedure illustrated in FIG. 7, k and l are natural numbers which represent the serial number of each region in the sequence of mismatching suspect derelict regions and the serial number of each region in the sequence of other predetermined types of object regions, respectively.

It shall be noted that the processes presented in the foregoing respective examples can be combined arbitrarily as needed in practice. Since the details of the respective processes have been described above with reference to the drawings, embodiments in which the respective processes are combined shall also be deemed as being encompassed in the disclosure of this specification though such embodiments are not described in detail here.

The device 100 for detecting a specific object in a sequence of images according to the embodiment of the invention described above with reference to FIG. 1 to FIG. 7 can be embodied as a separate device or incorporated into a video image camera monitor. For example in an alternative embodiment, the device 100 can be integrated with a video camera device so that the video camera device itself can perform a function of detecting a specific object (e.g., a derelict) in a sequence of captured images. Therefore the video camera device shall also be deemed to be encompassed in the scope of the invention.

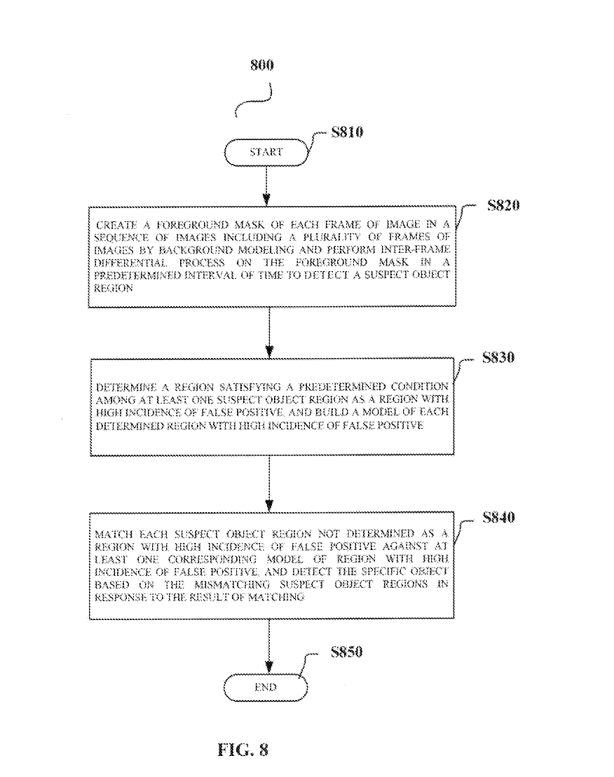

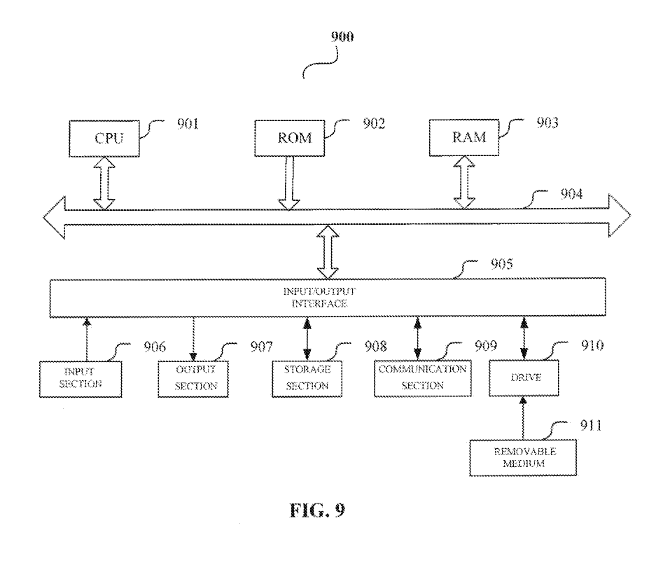

In another embodiment of the invention, there is further provided a method for detecting a specific object in a sequence of input images. FIG. 8 illustrates a simplified flow chart of a method 800 for detecting a specific object in a sequence of input images according to another embodiment of the invention.

As illustrated in FIG. 8, the method 800 starts with S810. In S820, a foreground mask of each frame of image in a sequence of images including a plurality of frames of images in a predetermined interval of time is generated through background modeling, and an inter-frame differential process is performed on the created foreground mask to detect a suspect object region. In S830, if at least one suspect object region is detected, then a region satisfying a predetermined condition among the at least one suspect object region is determined as a region with high incidence of false positive, and a model of each determined region with high incidence of false positive is built. In S840, if the at least one suspect object region is detected, then each suspect object region, which is not determined as a region with high incidence of false positive, is matched against at least one corresponding model of region with high incidence of false positive, and the specific object is detected, in response to the result of matching, according to a sequence of mismatching suspect object regions including all the mismatching suspect object regions which are not matched with respective corresponding model of region with high incidence of false positive. Absence of the specific object in the sequence of images is determined if no suspect object region is detected by the inter-frame differential process. The procedure in the method can be performed, for example, by the device 100 configured as illustrated in FIG. 1 and FIG. 2, and for specific details thereof, reference can be made to the foregoing description with reference to FIG. 1 and FIG. 2, a repeated description of which thus will be omitted here.

In a preferred embodiment, the process in S830 shown in FIG. 8 may further include generating a library of model of region with high incidence of false positive according to the built model of region with high incidence of false positive.

In a specific implementation of the method 800 illustrated in FIG. 8, the process of detecting the specific object in response to the result of matching can further include comparing each mismatching suspect object region in the sequence of mismatching suspect object regions with other predetermined types of object regions detected in the plurality of frames of input images. If the mismatching suspect object region is different from any of the other predetermined types of object regions, then the mismatching suspect object region is determined as a region corresponding to the specific object to be detected. In an alternative embodiment, all the mismatching suspect object regions in the sequence of mismatching suspect object regions can be determined directly as regions corresponding to the specific object to be detected. The procedure in this implementation can be performed, for example, by the device 100 capable of performing the procedure as illustrated in FIG. 7, and for specific details thereof, reference can be made to the foregoing description with reference to FIG. 7, a repeated description of which thus will be omitted here.

In another specific implementation of the method 800 illustrated in FIG. 8, the process of performing the inter-frame differential process to detect a suspect object region can include performing background modeling for the plurality of frames of images in the sequence of images using a mixed Gaussian model to create the foreground mask of each frame of image, and then performing the inter-frame differential process on the created foreground mask to extract pixels belonging to a moving foreground and also staying in the foreground status for the predetermined interval of time. A connectivity domain analysis is performed on the extracted pixels to generate the at least one suspect object region. The procedure in this implementation can be performed, for example, by the device 100 configured as illustrated in FIG. 1 and FIG. 2, and for specific details thereof, reference can be made to the foregoing description with reference to FIG. 1 and FIG. 2, a repeated description of which thus will be omitted here.

In another specific implementation of the method 800 illustrated in FIG. 8, the process of building a model of a region with high incidence of false positive includes: comparing the size of the at least one suspect object region with a predetermined first threshold, determining the suspect object region with a size larger than or equal to the predetermined first threshold as a region with high incidence of false positive, and building a Gaussian model at each pixel representing a foreground in the foreground mask of the region with high incidence of false positive to describe color information of an object at the pixel. The mean of the Gaussian model is the color value of the pixel, and the variance thereof is an initial variance of the Gaussian model or an empirical value of the variance. The foreground mask of the region with high incidence of false positive and the Gaussian model thereof can be stored in order to generate a library of model of region with high incidence of false positive. The procedure in this implementation can be performed, for example, with the device 100 capable of performing the procedure as illustrated in FIG. 5, and for specific details thereof, reference can be made to the foregoing description with reference to FIG. 5, a repeated description of which thus will be omitted here.

In a further specific implementation of the method 800 illustrated in FIG. 8, the process of detecting the specific object by the matching process includes: for each suspect object region, determining the number of matching pixels in the suspect object region which are matched with relevant pixels in the corresponding model of region with high incidence of false positive in the library of model of region with high incidence of false positive, and if the ratio of the number of the matching pixels to the number of pixels in the suspect object region is larger than a predetermined second threshold, then determining the suspect object region is matched with the corresponding model of region with high incidence of false positive. The procedure in this implementation can be performed, for example, with the device 100 capable of performing the procedure as illustrated in FIG. 6, and for specific details thereof, reference can be made to the foregoing description with reference to FIG. 6, a repeated description of which thus will be omitted here.

In another specific implementation of the method 800 illustrated in FIG. 8, the process of detecting the specific object by the matching process includes: if the difference between the color value of each pixel in the suspect derelict region and the mean of the Gaussian model of a pixel at a corresponding location in the corresponding model of region with high incidence of false positive is within twice the variance of the Gaussian model, then determining the two pixels are matched with each other. In an alternative implementation, a color probability density function can be built for each pixel of the model of region with high incidence of false positive, and if the value of the probability density function of a pixel in the suspect derelict region which corresponds to a pixel in the corresponding model of region with high incidence of false positive is larger than a predetermined threshold, then the two pixels are determined as being matched with each other.

It shall be noted that the respective embodiments and specific examples and implementations listed above are illustrative but not exhaustive and are not intended to limit the invention. For example, the respective specific examples and implementations listed in the foregoing respective embodiments can be combined arbitrarily as needed but shall not be limited only to the foregoing modes in which the specific examples and implementations are combined. Furthermore in the foregoing description of the respective embodiments and specific examples, the numerals, such as “1,” “2”, “one”, “two”, “the first” and “the second”, are merely intended to distinguish components or elements as referred to by these numerals but not to indicate any sequence between or degree of importance of these components or elements.

Furthermore the respective constituent units, sub-units and components in the device for detecting a specific object in a sequence of images as illustrated in FIG. 1, FIG. 2 and FIG. 5 to FIG. 7 can be configured in software, firmware, hardware or a combination thereof. The specific means or approach in which they can be configured is well known to those skilled in the art, and a repeated description thereof will be omitted here. In the case of being configured in software or firmware, a program constituting the software can be installed from a storage medium or a network on a computer with a dedicated hardware structure or a general-purpose computer (e.g., a general-purpose computer 900 as illustrated in FIG. 9), and the computer can perform various functions when various programs are installed thereon.

As illustrated in FIG. 9, a Central Processing Unit (CPU) 901 performs various processes according to a program stored in a Read Only Memory (ROM) 902 or loaded from a storage portion 908 into a Random Access Memory (RAM) 903. Data required when the CPU 901 performs the various processes is also stored in the RAM 903 as needed. The CPU 901, the ROM 902 and the RAM 903 are connected to each other via a bus 904 to which an input/output interface 905 is also connected.

The following components are connected to the input/output interface 905: an input section 906 including, e.g., a keyboard, a mouse; an output section 907 including a display, e.g., a Cathode Ray Tube (CRT), a Liquid Crystal Display (LCD), a speaker; a storage section 908 including a hard disk, etc.; and a communication section 909 including a network interface card, e.g., an LAN card, a modem. The communication section 909 performs a communication process over a network, e.g., the Internet. A drive 910 is also connected to the input/output interface 905 as needed. A removable medium 911, e.g., a magnetic disk, an optical disk, an optic-magnetic disk, a semiconductor memory can be installed on the drive 910 as needed, so that a computer program fetched therefrom can be installed into the storage portion 908 as needed.

In the case that the foregoing series of processes are performed in software, a program constituting the software is installed from a network, e.g., the Internet, or a storage medium, e.g., the removable medium 911.

Those skilled in the art shall appreciate that such a storage medium will not be limited to the removable medium 911 illustrated in FIG. 9 in which the program is stored and which is distributed separately from the device to provide the user with the program.

Examples of the removable medium 911 include a magnetic disk (including a Floppy Disk (a registered trademark)), an optical disk (including Compact Disk-Read Only memory (CD-ROM) and a Digital Versatile Disk (DVD)), an optic-magnetic disk (including a Mini Disk (MD) (a registered trademark)) and a semiconductor memory. Alternatively, the storage medium can be the ROM 902, a hard disk included in the storage section 908, etc., in which the program is stored and which are distributed together with the device including the same to the user.

The invention further proposes a program product in which machine readable instruction codes are stored. The instruction codes, when being read and executed by a machine, can cause the machine to perform the method for detecting a specific object (e.g., a derelict) in a sequence of input images according to the embodiment of the invention.

Correspondingly a storage medium carrying the program product with the machine readable instruction codes stored therein shall also be deemed to be encompassed in the disclosure of the invention. The storage medium may include but will not be limited to a floppy disk, an optical disk, an optic-magnetic disk, a memory card, a memory stick, etc.

In the foregoing description of the embodiments of the invention, a feature(s) described and/or illustrated in one embodiment can be used identically or similarly in one or more other embodiments in combination with or in place of a feature(s) in the other embodiment(s).

It shall be noted that the term “include/comprise” and any variants thereof as used in this disclosure refers to presence of a feature, element, a step or a component but will not preclude presence or addition of one or more other features, elements, steps or components.

Furthermore the methods and processes according to the respective embodiments of the invention shall be performed not only in the chronological sequence described in the specification, but also in any other appropriate chronological sequence, concurrently or separately. Therefore the scope of the invention shall not be limited to the sequence in which the various methods and processes according to the respective embodiments of the invention are performed as described in the present disclosure.

Although the invention has been disclosed above in the description of the embodiments thereof, it shall be appreciated that all the embodiments and examples described above are illustrative but not limiting. Those skilled in the art can devise various modifications, adaptations or equivalents to the invention without departing from the spirit and scope of the claims. These modifications, adaptations or equivalents shall also be deemed as falling into the scope of the invention.

1. A device for detecting a specific object in a sequence of images, comprising:
a suspect object region detection unit configured to create, for a sequence of images comprising a plurality of frames of images in a predetermined interval of time, a foreground mask of each frame of image in the sequence of images through background modeling, and perform an inter-frame differential process on the created foreground mask to detect a suspect object region;
a unit for modeling a region with high incidence of false positive configured to, if at least one suspect object region is detected by the suspect object region detection unit, determine a region satisfying a predetermined condition among the at least one suspect object region as a region with high incidence of false positive, and build a model of each determined region with high incidence of false positive; and
a post-processing unit configured to, if at least one suspect object region is detected by the suspect object region detection unit, match each suspect object region, which is not determined as the region with high incidence of false positive, against at least one corresponding model, and detect the specific object based on a sequence of mismatching suspect object regions comprising all the mismatching suspect object regions which are not matched with respective corresponding models; and, if no suspect object region is detected by the suspect object region detection unit, determine absence of the specific object in the sequence of images.

2. The device according to claim 1, wherein the unit for modeling a region with high incidence of false positive is further configured to generate a library of model of region with high incidence of false positive according to the model.

3. The device according to claim 1, wherein the post-processing unit is further configured to, if at least one suspect object region is detected by the suspect object region detection unit,
compare each mismatching suspect object region in the sequence of mismatching suspect object regions with other predetermined types of object regions, wherein the other predetermined types of object regions are detected in the plurality of frames of images, and determine the mismatching suspect object region as a region corresponding to the specific object to be detected if the mismatching suspect object region is different from any of the other predetermined types of object regions; or
determine all the mismatching suspect object regions in the sequence of mismatching suspect object regions as regions corresponding to the specific object to be detected.

4. The device according to claim 1, wherein the suspect object region detection unit is configured to perform background modeling for the plurality of frames of images using a mixed Gaussian model to build the foreground mask of each frame of image, perform the inter-frame differential process on the built foreground mask to extract pixels belonging to a moving foreground and staying in the foreground status for the predetermined interval of time, and perform a connectivity domain analysis on the extracted pixels to generate the at least one suspect object region.

5. The device according to claim 1, wherein the unit for modeling a region with high incidence of false positive is configured to, if the at least one suspect object region is detected by the suspect object region detection unit, determine a region with a size larger than or equal to a predetermined first threshold among the at least one suspect object region as a region with high incidence of false positive, and build a Gaussian model at each pixel representing a foreground in the foreground mask of the region with high incidence of false positive to describe color information of an object at the pixel, wherein the mean of the Gaussian model is the color value of the pixel, and the variance of the Gaussian model is an initial variance of the Gaussian model or an empirical value of the variance, and the unit for modeling a region with high incidence of false positive is further configured to generate a library of model of region with high incidence of false positive by storing the foreground mask of the region with high incidence of false positive and the corresponding Gaussian model.

6. The device according to claim 5, wherein the post-processing unit is configured to, if the at least one suspect object region is detected by the suspect object region detection unit, for each suspect object region, determine the number of matching pixels in the suspect object region which are matched with relevant pixels in the corresponding model of region with high incidence of false positive in the library of model of region with high incidence of false positive, and determine the suspect object region is matched with the corresponding model of region with high incidence of false positive if the ratio of the number of the matching pixels to the number of pixels in the suspect object region is larger than a predetermined second threshold.

7. The device according to claim 6, wherein the post-processing unit is configured to, if the difference between the color value of each pixel in the suspect object region and the mean of the Gaussian model of a pixel at a corresponding location in the corresponding model of region with high incidence of false positive is within twice the variance of the Gaussian model, determine the two pixels are matched with each other.

8. The device according to claim 6, wherein the post-processing unit is configured to build a color probability density function for each pixel of the model of region with high incidence of false positive, and when the value of the probability density function of a pixel in the suspect object region which corresponds to a pixel in the corresponding model of region with high incidence of false positive is larger than a predetermined third threshold, determine the two pixels are matched with each other.

9. A video camera device, comprising the device for detecting a specific object in a sequence of images, the device comprises:
a suspect object region detection unit configured to create, for a sequence of images comprising a plurality of frames of images in a predetermined interval of time, a foreground mask of each frame of image in the sequence of images through background modeling, and perform an inter-frame differential process on the created foreground mask to detect a suspect object region;
a unit for modeling a region with high incidence of false positive configured to, if at least one suspect object region is detected by the suspect object region detection unit, determine a region satisfying a predetermined condition among the at least one suspect object region as a region with high incidence of false positive, and build a model of each determined region with high incidence of false positive; and
a post-processing unit configured to, if at least one suspect object region is detected by the suspect object region detection unit, match each suspect object region, which is not determined as the region with high incidence of false positive, against at least one corresponding model, and detect the specific object based on a sequence of mismatching suspect object regions comprising all the mismatching suspect object regions which are not matched with respective corresponding models; and, if no suspect object region is detected by the suspect object region detection unit, determine absence of the specific object in the sequence of images.

10. A method for detecting a specific object in a sequence of images, comprising:
creating a foreground mask of each frame of image in a sequence of images comprising a plurality of frames of images in a predetermined interval of time through background modeling, and performing an inter-frame differential process on the created foreground mask to detect a suspect object region;
if at least one suspect object region is detected, determining a region satisfying a predetermined condition among the at least one suspect object region as a region with high incidence of false positive, and building a model of each determined region with high incidence of false positive; and
if at least one suspect object region is detected, matching each suspect object region, which is not determined as the region with high incidence of false positive, against at least one corresponding model, and detecting a specific object, in response to the result of matching, based on a sequence of mismatching suspect object regions comprising all the mismatching suspect object regions which are not matched with respective corresponding models; and, determining absence of the specific object in the sequence of images if no suspect object region is detected.

11. The method according to claim 10, wherein the process of building a model of each determined region with high incidence of false positive further comprises generating a library of model of region with high incidence of false positive according to the built model of region with high incidence of false positive.

12. The method according to claim 10, wherein the process of detecting the specific object in response to the result of matching further comprises:
comparing each suspect object region in the sequence of mismatching suspect object regions with other predetermined types of object regions detected in the plurality of frames of images, and if the mismatching suspect object region is different from any of the other predetermined types of object regions, determining the mismatching suspect object region as a region corresponding to the specific object to be detected; or
determining all the mismatching suspect object regions in the sequence of mismatching suspect object regions as regions corresponding to the specific object to be detected.

13. The method according to claim 10, wherein the inter-frame differential process comprises:
performing background modeling for the plurality of frames of images using a mixed Gaussian model to build the foreground mask of each frame of image, performing the inter-frame differential process on the built foreground mask to extract pixels belonging to a moving foreground and staying in the foreground status for the predetermined interval of time, and performing a connectivity domain analysis on the extracted pixels to generate the at least one suspect object region.

14. The method according to claim 10, wherein the process of building a model of each determined region with high incidence of false positive comprises:
comparing the size of each suspect object region with a predetermined first threshold, determining the suspect object region with a size larger than or equal to the predetermined first threshold as a region with high incidence of false positive, building a Gaussian model at each pixel representing a foreground in the foreground mask of the region with high incidence of false positive to describe color information of an object at the pixel, wherein the mean of the Gaussian model is the color value of the pixel, and the variance of the Gaussian model is an initial variance of the Gaussian model or an empirical value of the variance, and storing the foreground mask of the region with high incidence of false positive and the corresponding Gaussian model to generate a library of model of region with high incidence of false positive.

15. The method according to claim 14, wherein the process of detecting the specific object by the matching process comprises:
for each suspect object region, determining the number of matching pixels in the suspect object region which are matched with relevant pixels in the corresponding model of region with high incidence of false positive in the library of model of region with high incidence of false positive, and if the ratio of the number of the matching pixels to the number of pixels in the suspect object region is larger than a predetermined second threshold, determining the suspect object region is matched with the corresponding model of region with high incidence of false positive.

16. The method according to claim 15, wherein the process of detecting the specific object by the matching process comprises:
if the difference between the color value of each pixel in the suspect object region and the mean of the Gaussian model of a pixel at a corresponding location in the corresponding model of region with high incidence of false positive is within twice the variance of the Gaussian model, determining the two pixels are matched with each other.

17. The method according to claim 15, wherein the process of detecting the specific object by the matching process comprises:
building a color probability density function for each pixel of the model of region with high incidence of false positive, and if the value of the probability density function of a pixel in the suspect derelict region which corresponds to a pixel in the corresponding model of region with high incidence of false positive is larger than a predetermined third threshold, determining the two pixels are matched with each other.

18. A program product with machine readable instruction codes stored thereon, which when being read and executed by a machine can cause the machine to perform the method for detecting a specific object in a sequence of images according to claim 10.

19. A storage medium carrying thereon the program product according to claim 18.
